(19) United States
(12) Patent Application Publication
(10) Pub. No.: US 2018/0184827 A1
(43) Pub. Date: Jul. 5, 2018

(54) TABLE CLOTH CONTAINING CALCIUM CARBONATE RAW MATERIAL AND MANUFACTURING METHOD OF TABLE CLOTH

(71) Applicant: Xiang GU, Guangzhou City (CN)

(72) Inventor: Xiang GU, Guangzhou City (CN)

(21) Appl. No.: 15/666,916

(22) Filed: Aug. 2, 2017

(30) Foreign Application Priority Data
Jan. 4, 2017 (CN) 201710019675.4

(51) Int. Cl. A47G 21/16; C08J 5/18; C08L 23/06

(52) U.S. Cl. CPC A47G 21/16; C08J 5/18; C08L 23/06; C08J 2323/06; C08L 2207/066; C08L 2203/16; C08L 2205/025; C08L 2205/03; C08L 2207/062; C08J 2423/06

(57) ABSTRACT

A table cloth containing a calcium carbonate raw material and a manufacturing method of the table cloth, and relates to an environmentally-friendly fabric and a manufacturing method thereof. The table cloth comprises the following raw materials by weight percentage: 10-15% of a linear material, 6-9% of a high pressure material, 6-9% of a low pressure material, 2-3% of a master batch, and 60-80% of a modified filler, wherein the linear material is linear low density polyethylene; the high pressure material is low density polyethylene; the low pressure material is high density polyethylene; the master batch is color master batch; and the modified filler is calcium carbonate.

### TECHNICAL FIELD

The present invention relates to an environmentally-friendly fabric and a manufacturing method thereof, and more particularly, to an environmentally-friendly table cloth and a manufacturing method thereof.

### BACKGROUND

The catering industry, as a very important service sector in the tertiary industry of China, has always maintained a strong growth momentum and achieved rapid development, showing a prosperous new situation. At present, a large amount of table cloths is used in the catering sector as there are 4 million catering outlets in China, and it is required to wash the table cloth after a dinner every time. Nowadays, the environmental pollution is becoming increasingly serious, especially the pollution of water resources. No doubt that sewage discharge of thousands of washing plants all over the country is a main pollution source. As a result, many former greenish rivers in China have become stagnant and smelly pools due to serious negative nutrition of the water body; and especially, the pollution of inland rivers and lakes in some cities is more serious. Undeniably, these consequences are closely related to the sewage discharge of the washing plants. Therefore, it urgently needs to change this irrational situation today, and meanwhile, there is a pressing need to provide a disposable but low-pollution or pollution-free table cloth to solve this problem.

### SUMMARY

The present invention provides a table cloth containing a calcium carbonate raw material and a manufacturing method of the table cloth, and solves the problem of environmental pollution caused by washing table cloth in the prior art.

In order to solve the above problem, the present invention adopts the following technical solution: there is provided a table cloth containing a calcium carbonate raw material, the table cloth comprising the following raw materials by weight percentage: 10-15% of a linear material, 6-9% of a high pressure material, 6-9% of a low pressure material, 2-3% of a master batch, and 60-80% of a modified filler. The table cloth is prepared by mixing the raw materials, casting, embossing, printing and cutting.

The linear material is linear low density polyethylene.

The high pressure material is low density polyethylene.

The low pressure material is high density polyethylene.

The master batch is color master batch.

The modified filler is calcium carbonate.

A manufacturing method of a table cloth containing a calcium carbonate raw material comprises the following steps: (1) at room temperature, weighting the following raw materials by weight percentage: 10-15% of linear low density polyethylene, 6-9% of low density polyethylene, 6-9% of high density polyethylene, 2-3% of color master batch, and 60-80% of calcium carbonate; placing the raw materials mixed according to the parts into a mixing machine to be mixed evenly; (2) pouring the evenly mixed raw materials into a casting machine to be cast; (3) performing primary embossing during casting to form a thin film with a fine cloth pattern, and performing secondary embossing on the thin film to form a stone cloth with different patterns and colors; and (4) according to market demands, printing the stone cloth, then cutting the printed stone cloth, and finally packing the cut stone cloth.

Compared with the prior art, the present invention has the following benefits: 1, environmental protection is realized as the table cloth is made from a biodegradable material, and contains more than 65% of calcium carbonate which can be quickly decomposed in a natural environment; 2, the texture and visual sense of the table cloth are very close to those of traditional cloth; and 3, the table cloth can be called stone cloth because it contains more than 65% of calcium carbonate.

### DETAILED DESCRIPTION

The present invention will be described below in detail with reference to the preferred embodiments.

A table cloth containing a calcium carbonate raw material comprises the following raw materials in percentage by weight: 12.5% of a linear material (linear low density polyethylene), 7.5% of a high pressure material (low density polyethylene), 7.5% of a low pressure material (high density polyethylene), 2.5% of a master batch (color master batch), and 70% of a modified filler (calcium carbonate). The table cloth is prepared by mixing the raw materials, casting, embossing, printing and cutting.

A manufacturing method of a table cloth containing a calcium carbonate raw material comprises the following steps: (1) at room temperature, weighting the following raw materials in percentage by weight: 12.5% of a linear material (linear low density polyethylene), 7.5% of a high pressure material (low density polyethylene), 7.5% of a low pressure material (high density polyethylene), 2.5% of a master batch (color master batch), and 70% of a modified filler (calcium carbonate); placing the raw materials mixed according to the parts into a mixing machine to be mixed evenly; (2) pouring the evenly mixed raw materials into a casting machine to be cast; (3) performing primary embossing during casting to form a thin film with a fine cloth pattern, and performing secondary embossing on the thin film to form a stone cloth with different patterns and colors; and (4), according to market demands, printing the stone cloth, then cutting the printed stone cloth, and finally packing the cut stone cloth.

The stone cloth prepared by studying the features of traditional table cloth and carefully measuring has the following characteristics: 1, the stone cloth can be made into various colors of cloth and printed with different patterns; and 2, the stone cloth may have different thicknesses and toughness according to different purposes.

Finally, it should be noted that it is obvious that the above-described embodiments are merely illustrative of the examples of the present invention and are not intended to limit implementations. It will be apparent to those skilled in the art that various other changes or variations may be made on the basis of the above description. There is no need and no way to exhaust all the implementations. The obvious changes or variations therefrom are still within the protection scope of the present invention.

What is claimed is:

1. A table cloth comprising:
a calcium carbonate raw material, the table cloth further comprising the following raw materials by weight percentage: 10-15% of a linear material, 6-9% of a high pressure material, 6-9% of a low pressure material, 2-3% of a master batch, and 60-80% of a modified filler, wherein the table cloth is prepared by mixing the raw materials, casting, embossing, printing and cutting;
wherein the linear material is linear low density polyethylene;
the high pressure material is low density polyethylene;
the low pressure material is high density polyethylene;
the master batch is color master batch; and
the modified filler is calcium carbonate.

2. A manufacturing method of a table cloth containing a calcium carbonate raw material, the method comprising the following steps:
(1) at room temperature, weighting the following raw materials by weight percentage: 10-15% of linear low density polyethylene, 6-9% of low density polyethylene, 6-9% of high density polyethylene, 2-3% of color master batch, and 60-80% of calcium carbonate; placing the raw materials mixed according to the parts into a mixing machine to be mixed evenly;
(2) pouring the evenly mixed raw materials into a casting machine to be cast;
(3) performing primary embossing during casting to form a thin film with a fine cloth pattern, and performing secondary embossing on the thin film to form a stone cloth with different patterns and colors; and
(4) according to market demands, printing the stone cloth, then cutting the printed stone cloth, and finally packing the cut stone cloth.
